(19) United States
(12) Patent Application Publication
(10) Pub. No.: US 2006/0235944 A1
(43) Pub. Date: Oct. 19, 2006

(54) Method and system for a home screen editor in smartphone devices

(76) Inventor: Andrew David Mark Haslam, Sammamish, WA (US)

Correspondence Address: Andrew David Mark Haslam, 19604 SE 31st Pl, Sammamish, WA, 98075, US

(21) Appl. No.: 11/402,130

(22) Filed: Apr. 11, 2006

Related U.S. Application Data
(60) Provisional application No. 60/671,599, filed on Apr. 15, 2005.

(51) Int. Cl. G06F 15/16

(52) U.S. Cl. 709/217; 709/246

(57) ABSTRACT

A home screen editor technique is described for use in smartphone devices having an operating system (OS) capable of executing an application and/or interacting with an application executed on a remote computer that affects the smartphone. One such technique collates at least one application associated Plug-in data from different sources, presents the collated Plug-in data to a user, and enables the user to customize a Home Screen associated with the OS, where the customization at least in part being based upon the collated Plug-in data. Other customization techniques described enable the user to change at least one color associated with the Home Screen and/or the OS.

### CROSS-REFERENCE TO RELATED APPLICATIONS

The present Utility patent application claims priority benefit of the U.S. provisional application for patent No 60/671,599 filed on Apr. 15, 2005 under 35 U.S.C. 119(e).

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### FIELD OF THE INVENTION

The present invention relates generally to the editing of graphical user interface configuration parameters. More particularly, the invention relates to a user friendly “home screen” editor in Smartphone devices.

### BACKGROUND OF THE INVENTION

Smartphone devices that use Microsoft's™ operating system (hereafter referred to as a “Microsoft Smartphone”, or just “Smartphone”) display a “Home Screen” when the device is not in use. The home screen often shows users important information and other customized, user defined information. This home screen can be edited to some extent by the software that comes with the Smartphone from Microsoft™. For example, among other capabilities, the background screen can be changed, and the color scheme can be changed to several pre-defined settings. However, the conventional Smartphone is lacking a method of fully Customizing the Home Screen so that the user can configure it according to his or her preferences.

A Microsoft™ Smartphone device is an electronic device, usually encompassing a phone, which runs Microsoft's Windows CE™ or Windows Mobile as it is now called) operating system.

The color schemes for the Smartphone affect not only the colors of the text, Plug-ins and buttons on the Home Screen, but also the color of the message boxes, screen backgrounds in menus, selection color, and indeed the colors used throughout the entire Smartphone system. Currently the standard Microsoft software which comes with the Smartphone allows the use to change the colors to certain pre-defined “Color Schemes”. These Color Schemes are each given names. So, for example, “Luna” is a Color Scheme which changes most colors on the system to shades of blue. “Mint” is a Color Scheme which changes most colors on the system to shades of green. The user can therefore change the colors, but limited only to what Microsoft has specified in the predefined Color Schemes shipped with the device. A Smartphone user has no other way of customizing the colors on the system.

The Smartphone Home Screen is made up of various Plug-ins. A Plug-in is a DLL code item that displays some information on the screen. An example of a Plug-in is an item that displays the cellular network the user is connected to, the next appointment, or the battery life. Different Smartphone manufacturers install different Plug-ins on their Smartphones and give each Plug-in different settings.

The file that details how the Home Screen Should display itself is an XML file which details:
The background image that should be used.
The color scheme to use on this page, and throughout all aspects of the Smartphone user interface.
The Plug-ins that should be displayed, and which settings should be associated with each Plug-in (e.g. the size of the text, the color of the text).

Prior to the present invention, it was not possible to edit this XML file to display the Home Screen according to a user defined configuration. Instead, editing the XML file was very complicated—requiring detailed knowledge of how XML works, the ability to copy the file from a Smartphone to a PC, and the knowledge of what each element of the XML file commands.

By way of general background in the field of portable computing devices with informational greeting displays, another kind of portable computing device known as a “Pocket PC” offers a way to allow a user to edit its “Today Screen”, which is the Pocket PC equivalent of the Smartphone's Home Screen. However, the Today Screen is organized very differently to the way the Smartphone's Home Screen is laid out. The Today Screen is made up of Today Plug-ins. Each Today Plug-in is a DLL which does not need a unique identifier, but has to specify some Registry values to tell the Pocket PC system about itself. There presently is no known formal method for the Pocket PC Plug-in to expose its size and attributes. A Plug-in coder would have to create their own custom interface to do this, which would not be very useful unless the writer could get all Plug-in writers to use the same interface, and then write their own editor program to allow users to edit the Today Screen.

The Today Screen editor which was written for the Pocket PC by Microsoft allows the user to choose the order of the Plug-ins on the Today Screen, but as the way the Today Screen is ordered is vastly different to how it exists on the Smartphone (e.g. no XML files are used and just a few simple Registry entries which do not describe the Today Screen in great detail are utilized). In this way, it is to be understood that while the present invention does not apply to the Today Screen editor in the Pocket PC, the Pocket PC workings are helpful to understand the general issues relevant to the field of the present invention.

In view of the foregoing, there is a need for the ability to enable a user to easily edit the Home Screen of their Smartphone.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary color scheme editor method that enables users to change the colors on the Home Screen of their Smartphone, in accordance with an embodiment of the present invention;

FIG. 2 illustrates an exemplary block diagram of a software system suitable for carrying out the color scheme editor method shown in FIG. 1, in accordance with an embodiment of the present invention;

FIG. 3 illustrates an exemplary flow chart of a Plug-in editor method that enables user to choose which plug-ins they would like to display on their Home Screen, in accordance with an embodiment of the present invention

FIG. 4 illustrates an exemplary block diagram of a software system suitable of a method suitable for carrying out the plug-in editor method shown in FIG. 3, in accordance with an embodiment of the present invention;

FIG. 5 illustrates an exemplary flow chart of a method that enables the detection of Plug-ins on a Smartphone, in accordance with an embodiment of the present invention;

FIG. 6 illustrates an exemplary block diagram of a software system suitable for detecting Plug-ins shown in FIG. 5, in accordance with an embodiment of the present invention;

FIG. 7 illustrates an exemplary flow chart of a method that enables the detection of Plug-ins on a Smartphone, in accordance with an embodiment of the present invention.

FIG. 8 illustrates an exemplary block diagram of a software system suitable for executing the method of detecting Smartphone Plug-ins shown in FIG. 7, in accordance with an embodiment of the present invention;

FIG. 9 illustrates an exemplary flow chart of a method that enables the detection of Plug-ins on a Smartphone, in accordance with an embodiment of the present invention;

FIG. 10 illustrates an exemplary block diagram of a software system suitable for executing the method of detecting Plug-ins shown in FIG. 9, in accordance with an embodiment of the present invention;

FIG. 11 illustrates an exemplary flow chart of a method that enables the detection of Plug-ins on a Smartphone, in accordance with an embodiment of the present invention;

FIG. 12 illustrates an exemplary block diagram of a software system suitable for detecting Plug-ins shown in FIG. 11, in accordance with an embodiment of the present invention;

FIG. 13 illustrates an exemplary flow chart of a Plug-in data gathering method, in accordance with an embodiment of the present invention;

FIG. 14 illustrates an exemplary block diagram of a software system suitable of a method suitable for executing the Plug-in data gathering method shown in FIG. 13, in accordance with an embodiment of the present invention;

FIG. 15 illustrates an exemplary flow chart of a Plug-in data gathering method, in accordance with an embodiment of the present invention;

FIG. 16 illustrates an exemplary block diagram of a software system suitable for executing the Plug-in data gathering method shown in FIG. 15, in accordance with an embodiment of the present invention;

FIG. 17 illustrates an exemplary flow chart of a Plug-in data gathering method, in accordance with an embodiment of the present invention;

FIG. 18 illustrates an exemplary block diagram of a software system suitable of a method that is suitable for executing the Plug-in data gathering method in FIG. 17, in accordance with an embodiment of the present invention;

FIG. 19 illustrates an exemplary flow chart of a Plug-in data gathering method in accordance with an embodiment of the present invention;

FIG. 20 illustrates an exemplary block diagram of a software system suitable for executing the Plug-in data gathering method shown in FIG. 19, in accordance with an embodiment of the present invention;

FIG. 21 illustrates an exemplary method to acquire the information about each Plug-in that has been detected, in accordance with an embodiment of the present invention;

FIG. 22 illustrates an exemplary block diagram of a software system suitable for executing the method of acquiring information about each Plug-in that has been detected shown in FIG. 21 in accordance with an embodiment of the present invention;

FIG. 23 illustrates an exemplary method to acquire information about each Plug-in that has been detected, in accordance with an embodiment of the present invention;

FIG. 24 illustrates an exemplary block diagram of a software system suitable for executing the method illustrated in FIG. 23 to acquire information about each Plug-in that has been detected, in accordance with an embodiment of the present invention;

FIG. 25 illustrates a method of setting an edited XML file as the default Home Screen, in accordance with an embodiment of the present invention;

FIG. 26 illustrates an exemplary block diagram of a software system suitable for carrying out the method of setting an edited XML file as the default Home Screen, in accordance with an embodiment of the present invention; and

FIG. 27 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a variety of home screen editing techniques are described.

In particular, home screen editor techniques are provided for use in smartphone devices having an operating system (OS) capable of executing an application and/or interacting with an application executed on a remote computer that affects the smartphone. In one embodiment the technique, collates at least one application associated Plug-in data from different sources, presents the collated Plug-in data to a user, and enable the user to customize a Home Screen associated with the OS, the customization at least in part being based upon the collated Plug-in data. In a multiplicity of other embodiments, any combination of the following features/functions may additionally be performed: determining which of the at feast one Plug-ins are displayed on the Home Screen; collating the at least one Plug-ins that are displayed on the Home Screen; determining which properties associated with the at least one Plug-ins are displayed on the Home Screen; changing at least one color associated with the Home Screen and/or the OS.

A multiplicity of methods, systems, computer program products, means and/or steps for achieving some or all of the foregoing features or functions are also described.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

In one aspect, the present invention teaches of a system and method, which enables novice Smartphone users to edit their Home Screen and the colors throughout the Smartphone system according to the appearance they desire. This involves selecting which Plug-ins should be displayed on the Home Screen and the color scheme for the Home Screen and other screens throughout the Smartphone. In some embodiments, as will be described in some detail below, selecting which Plug-ins should be displayed on the Home Screen is achieved by providing a user interface that is capable of creating, or editing, an XML file that includes the appropriate settings to achieve the user specified Home Screen configuration, all without requiring the user to be aware of the detailed knowledge required.

To teach one skilled in the art how to make and use applications based on the present invention, various exemplary embodiments of the present invention will be described below with reference to the Figures.

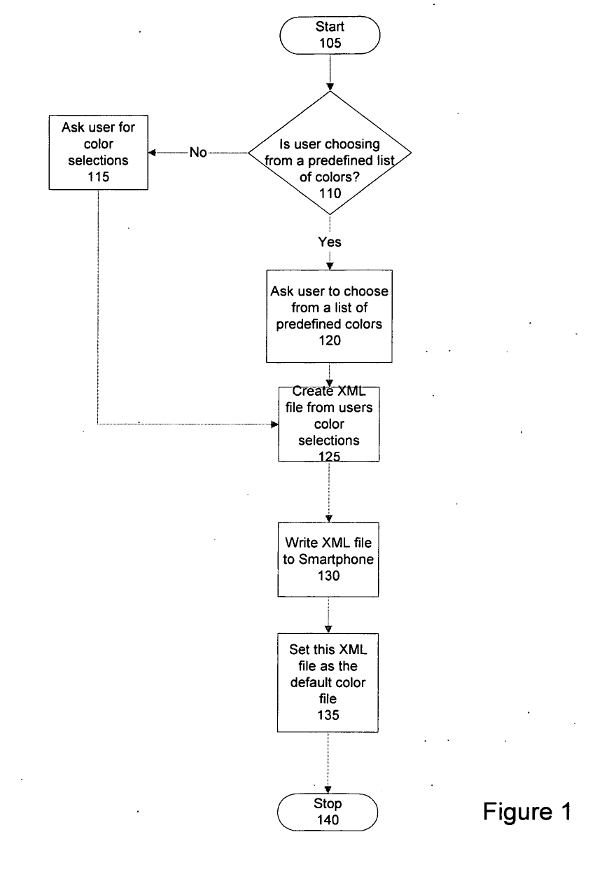

A color scheme editor will now be described in some detail, in accordance with an embodiment of the present invention. FIG. 1 illustrates a flow chart or a method that enables users to change the colors of different features on the Home Screen of their Smartphones, in accordance with an embodiment of the present invention. A color scheme editor of the present embodiment will either create a new XML file or edit an existing XML file with new data the user enters into the user interface. For example, the user may decide to change text color on the Smartphone's Home Screen. The method begins with the user initiating a process start at Step 105 which will prompt the user to pick a color at Step 110. Also, at Step 110, the user will make a determination if default colors or a custom color will be displayed, for example, the user may choose from a list of colors, or may enter the red, green & blue values that make up the custom color. In the method of changing colors of different features on the Home Screen, the user will be prompted by a request asking for color selections at Step 115 when not choosing from a predefined list of colors from Step 110. For example, if the user would choose the text color on the Home Screen to be yellow (a red, green; blue value of 255, 255, 0), the present embodiment would write a line of XML code reading:
<color name=“COLOR_HOMETEXT” value=“#FFFF00”/>

In this example, the “255” decimal values have been converted into hexadecimal (“FF”).

If the user chooses to use a predefined color from a list at Step 110, user will be prompted with a request to choose from a list of predefined colors at Step 120. Either the custom Home Screen color selected at Step 115 or selecting from a predefined color at Step 120, the method then takes this request and creates a file into XML instructions at Step 125. A write of the created XML file to the Smartphone memory occurs at Step 130 whereby a newly defined default color will be set at Step 135. A termination of the method process occurs at Step 140.

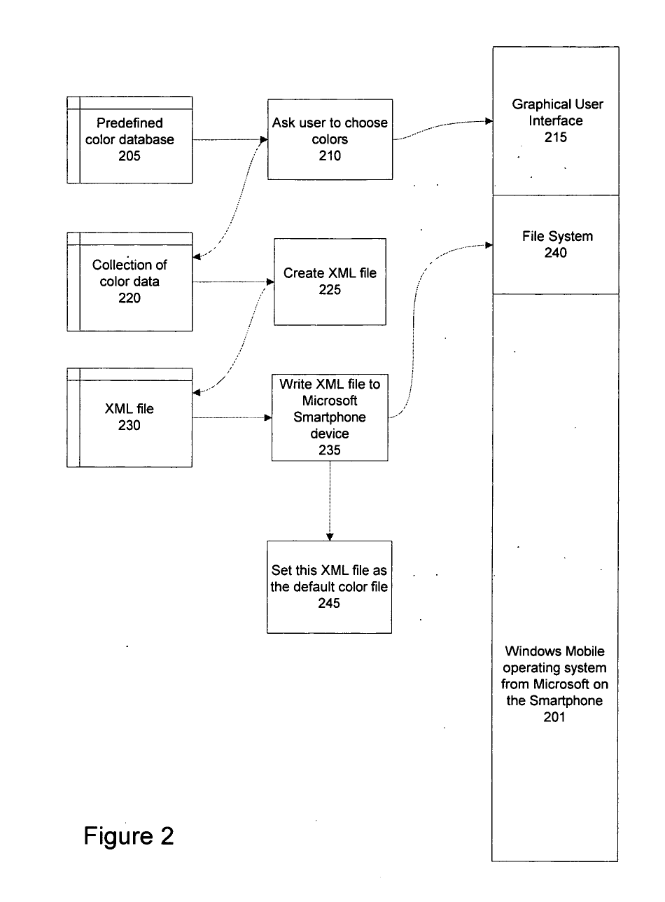

FIG. 2 illustrates a block diagram of a software system that is suitable for carrying out the method that enables users to change the color on the Home Screen of their Smartphone as shown in FIG. 1, in accordance with an embodiment of the present invention. The Microsoft™ Smartphone operates on a Windows™ based mobile operating system 201 that comprises a Graphical User Interface 215 (e.g. visual user display) and a File System 240. Mobile operating system 201 contains a predefined color database 205 comprising just a few or literally thousands of color display possibilities. Whether the user chooses to use a default color from the predefined color database 205 or select a Custom color, a user prompt asking use to choose colors by a prompting module 210 displays on Graphical User Interface 215. A collection of color data is stored in internal storage at 220 resulting from user choosing colors at 21 0. This data can include background colors, text colors, etc. The software system then creates a file in XML by an XML file generation module 225, creates a file location in internal storage at 230, and writes a file in XML to the Microsoft Smartphone device an XML file storage module 235 to be saved in the File System 240 and a default color file configuration module 245 takes the XML file and sets it as the new default color file.

In Diagram 1 below, the “COLOR_HOMETEXT” in the XML code above is replaced with the data in column 1, thus altering the colors of the features displayed in corresponding column 2.

Diagram 1

| Column 1 | Column 2 |
|---|---|
| COLOR_WINDOW | Window background color |
| COLOR_STATIC | Dialog background color |
| COLOR_STATICTEXT | Dialog text color |
| COLOR_HIGHLIGHT | Highlight background color |
| COLOR_HIGHLIGHTTEXT | Highlight text color |
| COLOR_MENU | Menu background color |
| COLOR_MENUTEXT | Menu text color |
| COLOR_GRAYTEXT | Grayed menu item text color |
| COLOR_GRADLEFT | Background 1 gradient left color |
| COLOR_GRADRIGHT | Background 1 gradient right color |
| COLOR_INTGRADLEFT | Background 2 gradient left color |
| COLOR_INTGRADRIGHT | Background 2 gradient right color |
| COLOR_TRAYGRADLEFT | Title bar gradient left color |
| COLOR_TRAYGRADRIGHT | Title bar gradient right color |
| COLOR_HIGHGRADLEFT | Item highlight gradient left color |
| COLOR_HIGHGRADRIGHT | Item highlight gradient right color |
| COLOR_TRAYTEXT | Title bar text color |
| COLOR_WINDOWFRAME | Border of the window color |
| COLOR_BTNFACE | Unselected button background |
| | color |
| COLOR_BTNTEXT | Unselected button text color |
| COLOR_SCROLLBAR | Scroll bar stripes color |
| COLOR_HOMETEXT | Home Screen text color |
| COLOR_HOMEHIGHLIGHT | Home Screen Plug-in highlight |
| | color |
| COLOR_HOMEHIGHLIGHTTEXT | Home Screen Plug-in highlight |
| | text color |
| COLOR_HOMERULE | Home Screen separator color |
| COLOR_WINDOWTEXT | Standard window text color |
| COLOR_ALERTWINDOW | Alert window color |
| COLOR_ALERTTITLE | Alert title bar color |
| COLOR_ALERTRULE | Alert screen separator color |

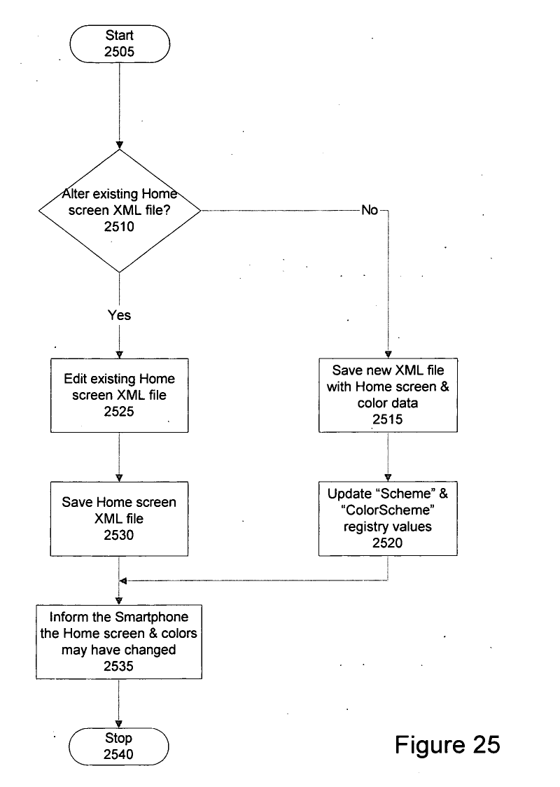

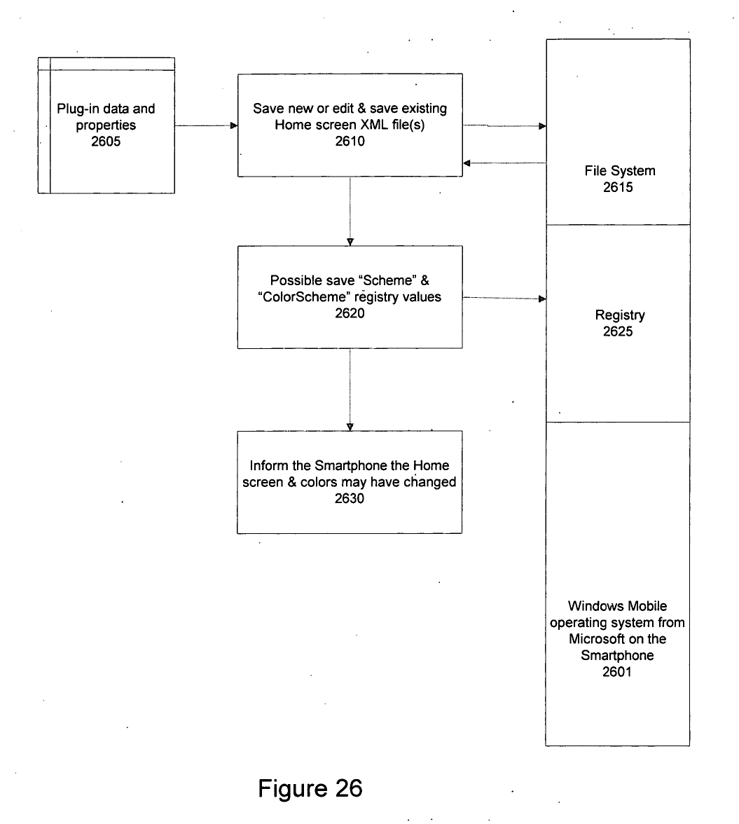

Once the user has chosen the colors they wish to use (or chosen from a list of pre-defined colors the present embodiment may have chosen for them—e.g. a red color scheme, a blue color scheme), then this information is stored in an XML file. This is either the currently selected color scheme XML file, or a new, color scheme XML file. This will be explained in the section below, FIGS. 25 and 26, on how the present embodiment sets this XML file as the default color scheme XML file.

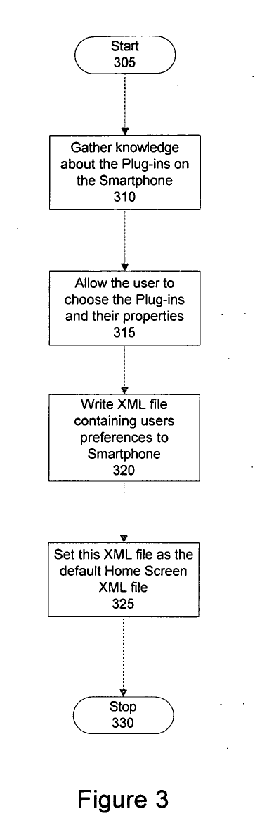

A Plug-in editor will now be described in some detail, in accordance with an embodiment of the present invention. FIG. 3 illustrates a flow chart of a method that enables users to choose which Plug-ins they would like to display on their Home Screen, in accordance with an embodiment of the present invention. The method begins with the user initiating a process start at Step 305 most likely through manual selection. All existing Plug-ins on the Smartphone are scanned in a process at 310 to gather knowledge about the existing Plug-ins. From a list of Plug-ins, the user is able to select which Plug-ins to activate and define their properties such as color or location at Step 315. A file in XML is then written to the Smartphone containing the user-defined preferences at Step 320 where a default Home Screen XML file is set at Step 325. A termination of the method process occurs at Step 330.

The Plug-in editor of the present embodiment needs to have some knowledge of which Plug-ins are on the user's Smartphone. This information can be gleamed by several methods. One way to do this is to store the information in the Smartphone's file system. That is, the Smartphone file system is pre-loaded with data about which Smartphones have which Plug-ins installed on them. This would allow the existing Plug-ins to be edited, but could have a problem with identifying if new Plug-ins were loaded onto the Smartphone after it was purchased (e.g. from 3^{rd} party manufacturers).

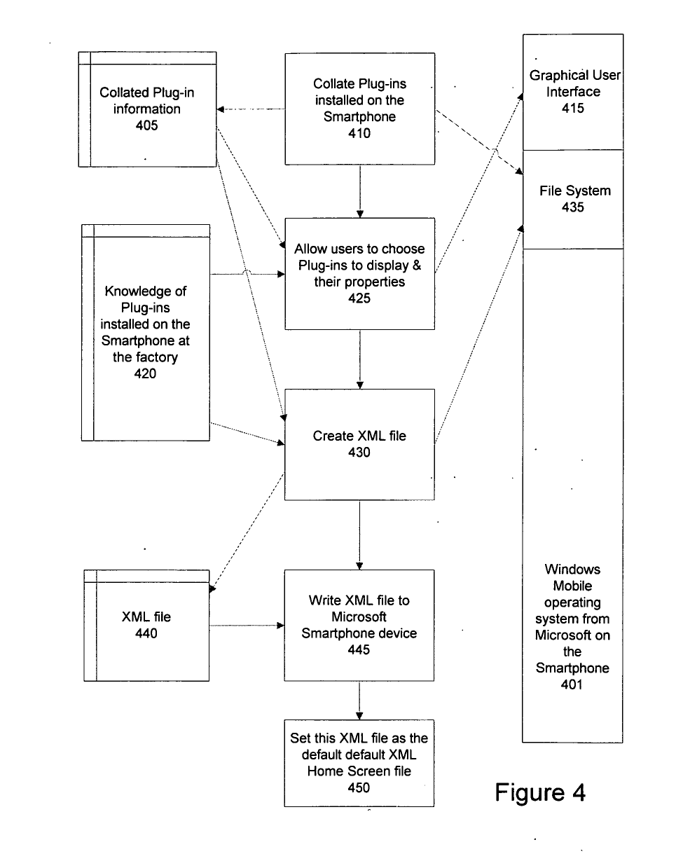

FIG. 4 illustrates a block diagram of a software system that is suitable for carrying out the method of the Plug-in editor shown in FIG. 3, in accordance with an embodiment of the present invention. The Microsoft Smartphone operates on a Windows based mobile operating system 401 that comprises a Graphical User Interface 415 and a File System 435. File System 435 within Mobile operating system 401 undergoes a collation process by a collation module 410 and accumulates in a file of collated Plug-in information 405. Looking at a Graphical User Interface 415, a user is allowed to select which Plug-ins to display and change Plug-in properties by a plug-in properties module 425. Also, a knowledge database 420 containing factory-installed Plug-in information is displayed on Graphical User Interface 415 so that a user is allowed the opportunity to edit knowledge database 420 Plug-ins, should they wish.

An XML file generation module 430 creates XML files from the users choices in 425, and data from 420 and 405. It is then stored in the Win32 File System 435. A stored XML file relating to a Plug-in XML file 440 is written to a file on the Microsoft Smartphone using XML file storage module 445. Module 450 takes the XML file and sets it as the new default XML, Home Screen file.

The Plug-in editor of the present embodiment would then collate information about all the Plug-ins on the system allowing the user to choose between them. The information could be as simple as providing the name of the Plug-in (or the class ID (CLSID or unique identifier)) so it can be identified. The present embodiment could also store more detailed information about each Plug-in. For example, without limitation, how the Plug-in is displayed on the screen, what it should allow the user to do, its size, as well as other parameters that the user may find useful to adjust.

Once the information about each of the Plug-ins is collated, this information is then presented to the user to allow them to choose not only which Plug-ins they want to display on the Home Screen, but their position, size, orientation, color and any other information the Plug-in manufacturer allows to be adjusted.

Once the user has finished making their adjustments the Plug-in editor will then store this information to an XML file (either by creating a new XML file, or editing an existing XML file).

The order of the Plug-ins is preferably determined by the order of the Plug-ins in the XML file. The position of some Plug-ins can also be chosen by specifying an x, y screen position.

Exemplary methods of detecting the Plug-ins will now be described in some detail, in accordance with an embodiment of the present invention. In one embodiment, detecting the Plug-ins is accomplished by manually searching for all the Plug-ins on each Smartphone which has been released. This would be done by either the user looking through technical documentation of the Smartphone, going through all the XML files on the Smartphone to discover which Plug-ins were referenced and how they were referenced, by using a computer program to test each file on the Smartphone to determine if it exposes one or many Plug-ins and the capabilities of those Plug-ins, by looking at the Smartphone's Registry to determine what Plug-ins are on the device and what their capabilities are, or by looking at any other elements on the system that would give the information about the Plug-ins.

The knowledge of each of these Plug-ins, and which features they expose would then be used to allow the users to choose which Plug-ins they wanted on the Home Screen, where they wanted the Plug-ins and how they wanted each Plug-in to appear.

In another embodiment of detecting which Plug-ins are available on a particular Smartphone is to look for all the Plug-ins that are currently installed on the Smartphone at or close to the time the user wants to choose the Plug-ins for their Home Screen. In this example, a computer program would run on the Smartphone or on a computer the Smartphone was connected to (for example, a PC connected by a wired or wireless connection, or a computer server connected by a network such as the Internet). This program analyzes the Smartphone for Plug-ins in much the same way as the “manual” method above (i.e. the program looks at the XML files, files, Registry or any other information to determine what Plug-ins were installed on that Smartphone).

This alternate method determines what Plug-ins are on the Smartphone at the time the user wishes to edit their Home Screen. This is useful as the user may have installed extra Plug-ins on their Smartphone which didn't come with the original device, or may have a Smartphone which wasn't one which was manually searched, and so wasn't supported.

In yet another embodiment, another way to work out which Plug-ins are available on a particular Smartphone is to ask the user to enter the details of the Plug-ins that are installed on their Smartphone. Once the user had entered the Plug-in information the present embodiment has the information it needs to allow the user to edit the Home Screen.

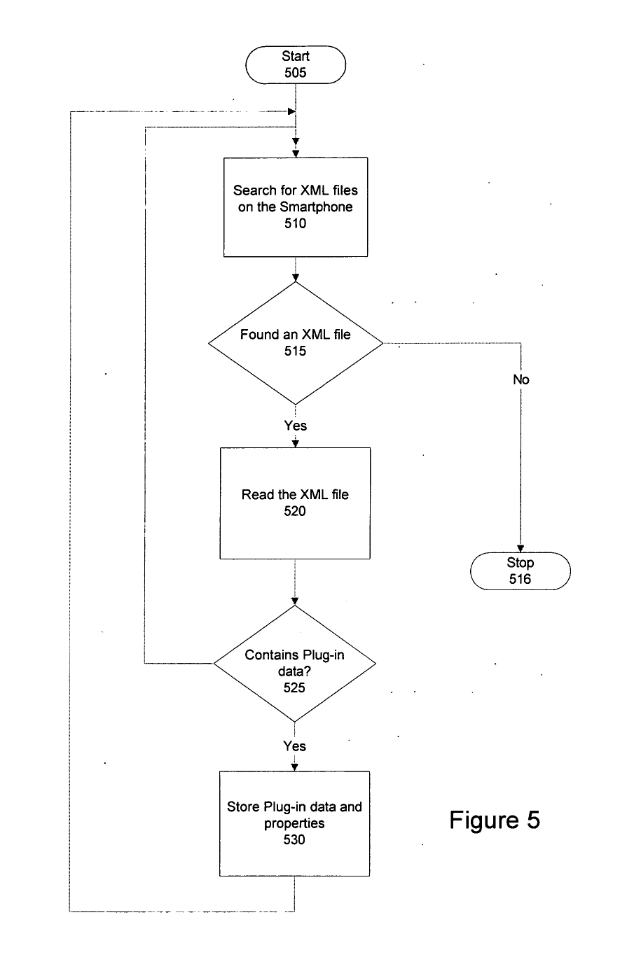

A first exemplary method of detecting the Plug-ins will now be described in some detail, in accordance with an embodiment of the present invention. FIG. 5 illustrates an exemplary flow chart of a method that enables the detection of Plug-ins on a Smartphone, in accordance with a first Plug-in detection method embodiment of the present invention. The method begins with the user initiating a process start at Step 505 most likely through manual selection. A file search at Step 510 reads all the files on the Smartphone system, looking for any files with a .xml extension. If a file is not found at Step 515, the method will terminate a file search at Step 516. If a file is found at Step 515, a file read at Step 520 reviews the file for a tell-tale tag to show this is a Home Screen file with Plug-in data. There are many ways to determine this, as many tags in the Home Screen XML files are similar, however some possible ways to detect this is to detect a <home>, <scheme> or </plugin> tag. XML files not containing Plug-in data will be skipped and the search for additional XML files on the Smartphone will continue at Step 510. XML files containing Plug-in data, as determined at Step 525, will be routed to a storage location at Step 530.

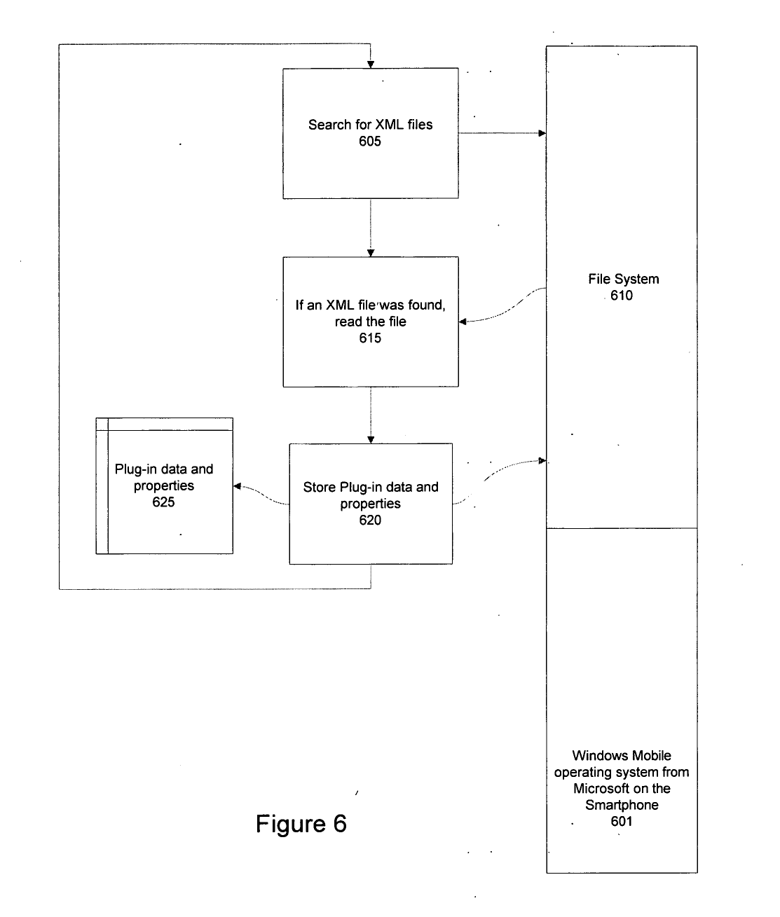

FIG. 6 illustrates an exemplary block diagram of a software system suitable for detecting Plug-ins as shown in FIG. 5, in accordance with a first Plug-in detection system embodiment of the present invention. The Microsoft Smartphone operates on a Windows based mobile operating system 601 that comprises a File System 610. A XML searching module 605 conducts a search for XML files on the File System 610. A file located on File System 610 that is an XML file is read in an XML file reading module 615. An XML file storage module 620 stores the read XLM file comprising Plug-in data and properties to a file 625 within File System 610. This search process repeats until the entire File System 610 has been searched for XML files with Plug-ins.

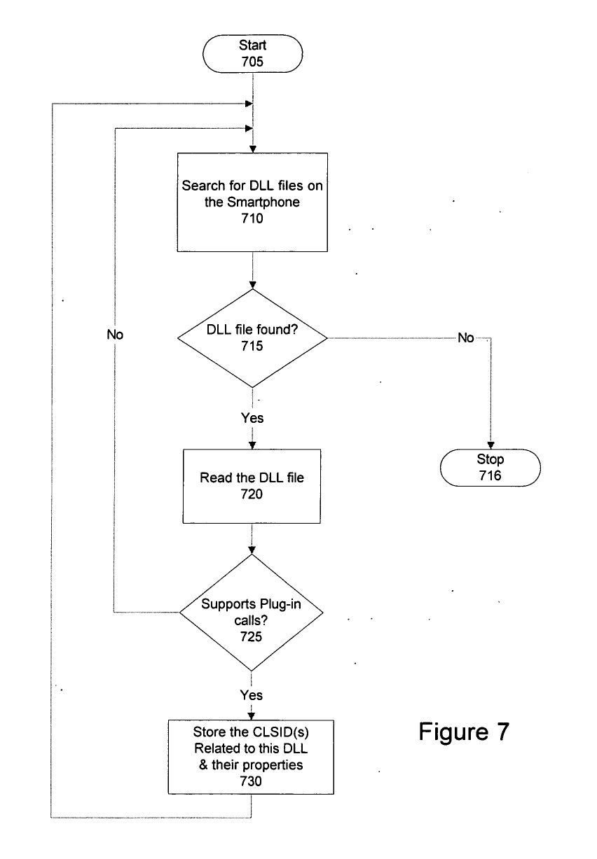

A second exemplary method of detecting the Plug-ins will now be described in some detail, in accordance with an embodiment of the present invention. FIG. 7 illustrates an exemplary flow chart of a method that enables the detection of Plug-ins on a Smartphone, in accordance with a second Plug-in detection method embodiment of the present invention. The method begins with the user initiating a process start at Step 705 most likely through manual selection. A DLL file search at Step 710 reads all the files on the Smartphone system. If a file is not found at Step 715, a file search terminates at Step 716. If a file is found at Step 715, a file read at Step 720 reviews the file to determine if the file supports Plug-in calls. This is done by detecting if the DLL supports certain function calls. DLL files that do not support Plug-in calls are skipped and additional searching for other DLL files continues. If a DLL file supports Plug-in calls, a storage file 730 stores this Class ID as belonging to a Plug-in along with any other properties or attributes the Plug-in Supports.

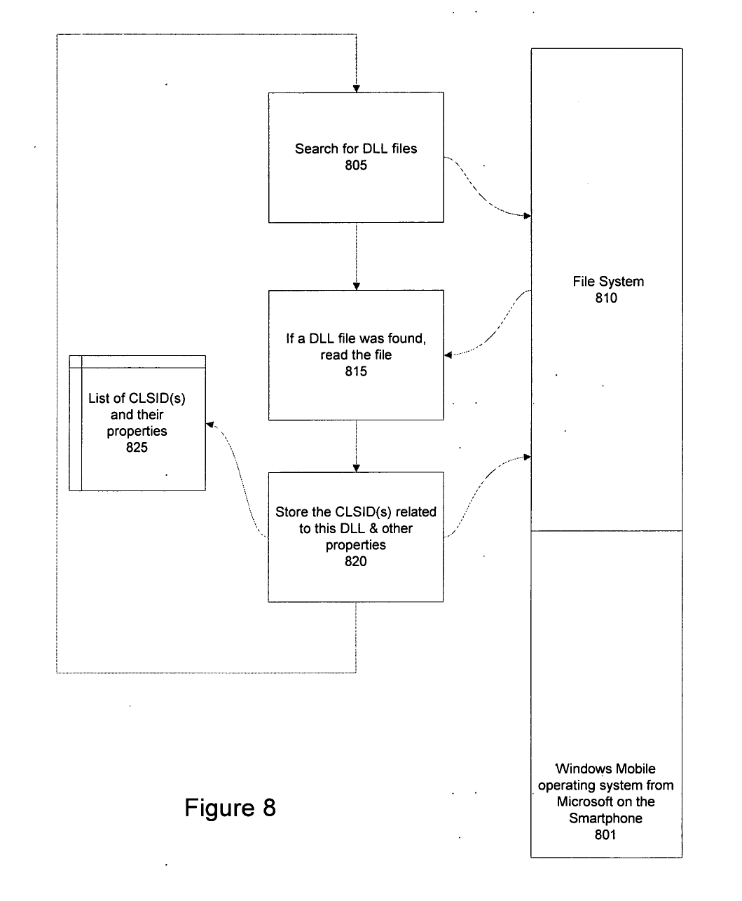

FIG. 8 illustrates an exemplary block diagram of a software system suitable for detecting Smartphone Plug-ins as shown in FIG. 7, in accordance with a second Plug-in detection system embodiment of the present invention. The Microsoft Smartphone operates on a Windows based mobile operating system 801 that comprises a File System 810. A software search is commenced by a DLL searching module 805 for a DLL file located on File System 810. If a DLL is found the DLL file is read by a DLL reading module 815. CLSID(s) related to each DLL and other properties that were read from DLL read by DLL reading module 815 are stored by a storage module 820 to a CLSID storage location 825 within File System 810. This search process repeats until the entire File System 810 has been searched for DLL files.

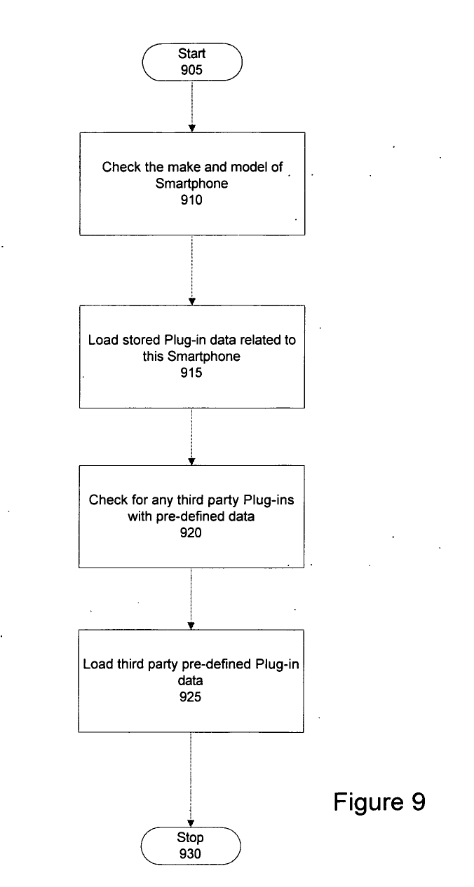

A third exemplary method of detecting Plug-ins will now be described in some detail, in accordance with an embodiment of the present invention. FIG. 9 illustrates an exemplary flow chart of a method that enables the detection of Plug-ins on a Smartphone, in accordance with a third Plug-in detection method embodiment of the present invention. All references to Plug-ins are gained by looking at technical documentation from the Smartphone manufacturer or distributor, or other source that may have information about the Plug-ins and what their capabilities are. This information is then collated together and distributed so the user knows which Plug-ins are available. The method begins with the user initiating a process start at Step 905 most likely through manual selection. A system scan at Step 910 can then check for the particular make of Smartphone it is editing by asking the user to enter the details, or by detecting the make by using function calls on the Smartphone itself. Details from the system scan at Step 910 are loaded at Step 915. A scan for any third party Plug-ins with predefined data at Step 920 (usually, but not always these are added after the product has been shipped) is forwarded to a load command at 925. If the inventor has stored pre-defined information about each Plug-in, this information could also be utilized. A method termination occurs at 930.

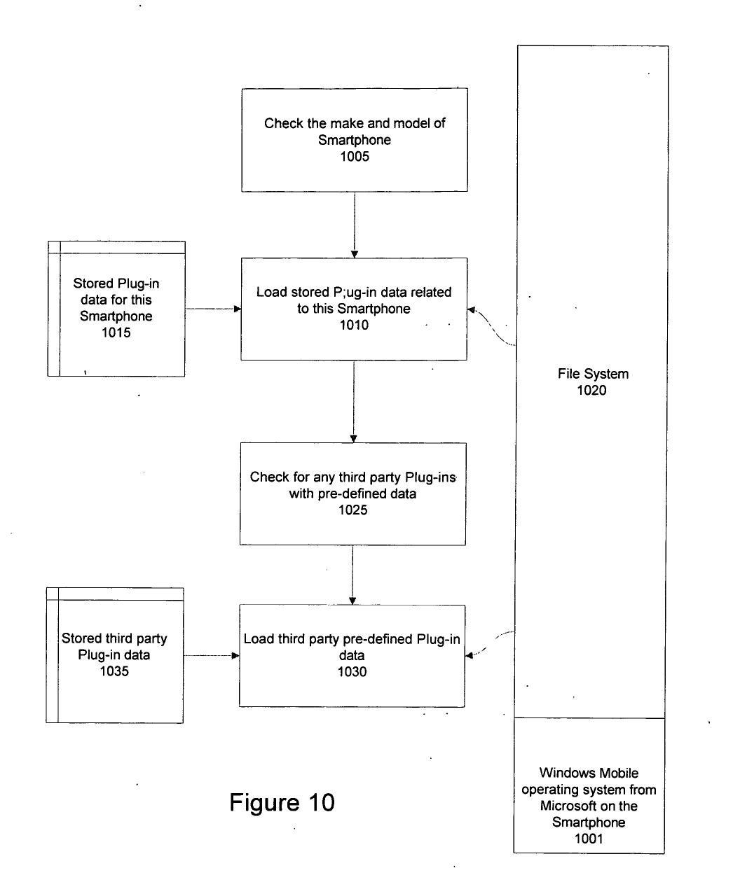

FIG. 10 illustrates an exemplary block diagram of a software system suitable for carrying out the method shown in FIG. 9, in accordance with a third Plug-in detection system embodiment of the present invention. The Microsoft Smartphone operates on a Windows based mobile operating system 1001 that comprises a File System 1020. A module 1005 searches for a Plug-in by checking a make and model registry (not shown). Information regarding these Smartphone stored data details (e.g., Plug-in data) found by module 1005 is loaded by a retrieval module 1010 from a file containing stored Plug-in data at 1015 from within File System 1020. A module 1025 receives the retrieved plug-in data and checks for any third party Plug-ins with this predefined data. The Smartphone third party data details found by module 1025 is communicated to a plug-in loading module 1030 that loads stored third part), Plug-in data related to this Smartphone from a storage file containing third party Plug-in data at 1035 from within File System 1020.

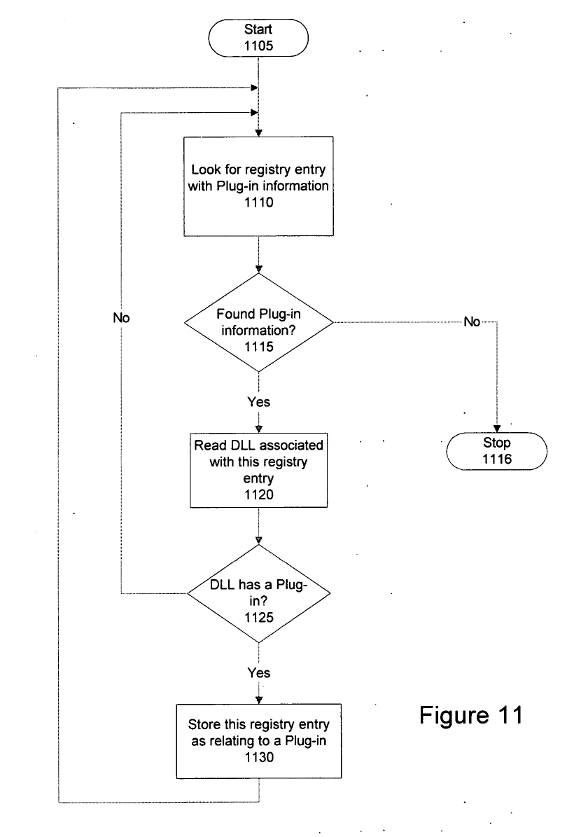

A fourth exemplary method of detecting the Plug-ins will now be described in some detail, in accordance with an embodiment of the present invention. FIG. 11 illustrates an exemplary flow chart of a method that enables the detection of Plug-ins on a Smartphone, in accordance with a fourth Plug-in detection method embodiment of the present invention. The method begins with the user initiating a process start at Step 1105 most likely through manual selection. A file search at Step 1110 searches all the Registry keys on the Smartphone looking for information about the Plug-in. For example, the information for the “startmru” Plug-in is found by looking in the HKEY_CLASSES_ROOT\CLSID key for references to any .dll file. All the files are then subjected to tests to see if they Support Plug-in operations using the Class ID (CLSID) associated with this DLL (in this case {79EFB752-CB70-446d-B317-499723482B3D}). This is done by detecting if the DLL supports certain function calls. If such a file is not found at Step 1115, the method will terminate a file search at Step 1116. If a file with Plug-in information is found at Step 1115, this Class ID is recorded as belonging to a Plug-in and a file read at Step 1120 reviews the file for a DLL associated with this registry entry. DLL file storage takes place at Step 1125 thereby routing a registry entry to a storage location as relating to a Plug-in at Step 1130. If DLL file storage at Step 1125 determines that the DLL does not have a Plug-in, the process will repeat itself looking for additional entries with Plug-in information.

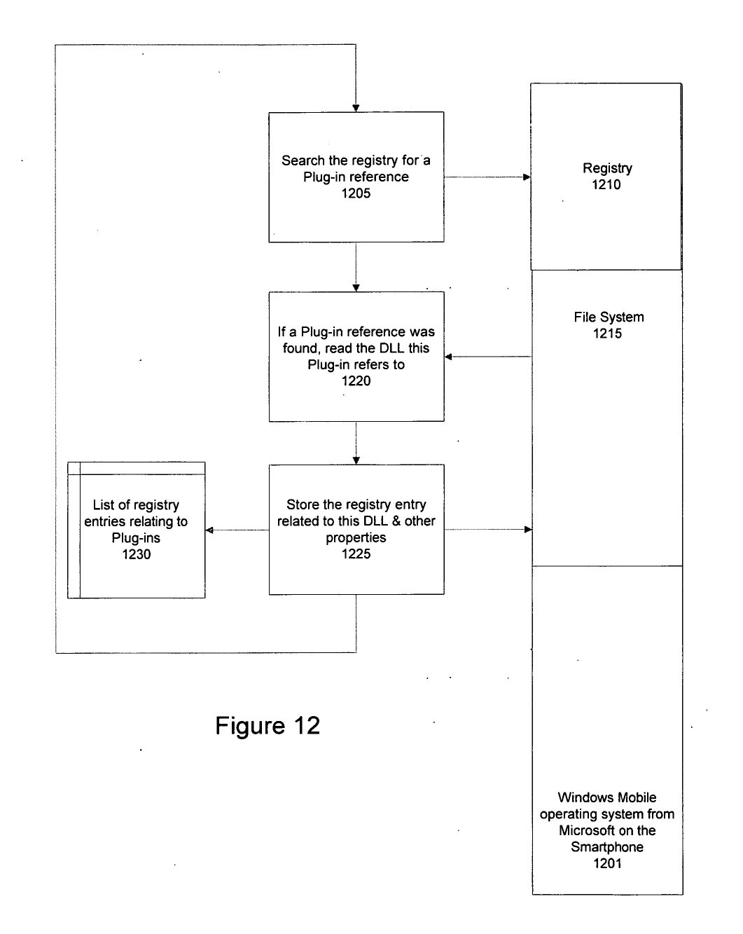

FIG. 12 illustrates an exemplary block diagram of a software system suitable for carrying out the method of detecting Plug-ins as shown in FIG. 11, in accordance with a fourth Plug-in detection system embodiment of the present invention. The Microsoft Smartphone operates on a Windows based mobile operating system 1201 that comprises a Registry 1210 and a File System 1215. A Plug-in reference searching module 1205 conducts a registry search for a Plug-in reference on the Registry 1210. A Plug-in reference found on Registry 1210 by Plug-in reference searching module 1205 is communicated to an DLL file reading module 1220, which reads the DLL on File System 1215 that the Plug-in refers to. A file storage module 1225 in the software stores registry entry data and properties to a list file 1230 of registry entries relating to Plug-ins within File System 1215. This search process repeats until a search of entire Registry 1210 returns no additional Plug-in references.

Collating the Information

Once each Plug-in and the information about how it can be customized have been gathered, this information should be collated so it can be presented to the user. A exemplary method and system for collating the Plug-in information will now be described in some detail, in accordance with an embodiment of the present invention.

Each Smartphone Plug-in has a unique identifier associated with it. This is known as a Class ID or CLSID. For example, the Microsoft “Start MRU” Plug-in is defined in the XML file thus:

<plugin clsid=“{79EFB752-CB70-446d-B317-499723482B3D}”
name=“startmru” height=“38”>
<mru icon_size=”32” y=“2” x=”10”/>
</plugin>

One embodiment of the present invention uses the information stored here to work out the CLSID of the Plug-in (in this case 79EFB752-CB70-446d-B317-499723482B3D, the readable name “startmru”, and any other information about how this can be utilized. In the above case the default height (38 pixels) can be determined, as well as an optional values that can be specified. In this case: icon size=32, which controls the size of the icons to be displayed on the Plug-in, y=2, which controls how far from the top of the Plug-in the icons are displayed and x=10, which controls how far from the left hand edge of the Plug-in the icons are displayed.

From the Registry one can find out the startmru Plug-in alternate name “SPStartMRU” and the DLL associated with it “tpcutil.dll”. From here, a computer program can be used to probe the Plug-in DLL file to determine if it contains any other special features. By using these and other techniques, one gains a detailed understanding of all the Plug-ins on the Smartphone. This information is then presented to the user in a computer program to allow them to choose which Plug-ins should be displayed on their Smartphone, the positioning of the Plug-ins on the Smartphone screen, and the optional settings for each Plug-in.

This is the preferred method to finding out the information about the Plug-ins on the system. This method allows the present embodiment to work on any Smartphone currently produced, but also Plug-ins produced after the production of the Smartphone. This method will also work with any third party Plug-ins the user may install after the Smartphone has been purchased.

In a first Plug-in information retrieval embodiment once a reference to a Plug-in has been detected (for example, from an XML file, a DLL or from a Registry key) an algorithm goes through the XML file looking for any Plug-ins that are on the system. One way of searching the XML file is by parsing the file looking for text starting with “<plugin” and ending with “</plugin>”. The information contained within those start & end parameters describe the Plug-in.

For each Plug-in, the CLSID is an important property to get. One way of searching for CLSID is by searching for the “clsid=” tag within the Plug-in tags. The list of numbers & letters that follow this are the unique identifier, or Class ID for this Plug-in. For example:

cisid=“{837FC251-FE69-43ad-84E0-EBCEDEBA0884}”

A Plug-in may also have an x or y value that describes it (such as Cartesian coordinates). One way this will be found is in the “x=” or “y=” tags. The number following this tag describes the x & y starting position of the data from the top of the Plug-in origin. For example, if the Plug-in were the topmost item on the Home Screen, its Plug-in origin would be (0,0). If x=5, y=10 were specified in this Plug-in then the data to display would start being displayed at (5,10) on the screen.

The Plug-in may also have other tags that describe other features of the Plug-in that can be altered. For example, a readable name (name=“iconbar”), or a height for the Plug-in to be displayed on the screen (height=“20”). One embodiment of the present invention passes these items on to the user to allow the user to manually edit them.

There are issues with sharply passing this information on to the user. For example, if a tag hold=“2”—it may be clear that this value to “2”, but it is not clear what other settings the tag can be set to. Setting the tag to another value may cause the Plug-in to crash, and hence crash the whole operating system running on the Smartphone. Various methods are described by way of example below towards working out attribute values for Plug-ins.

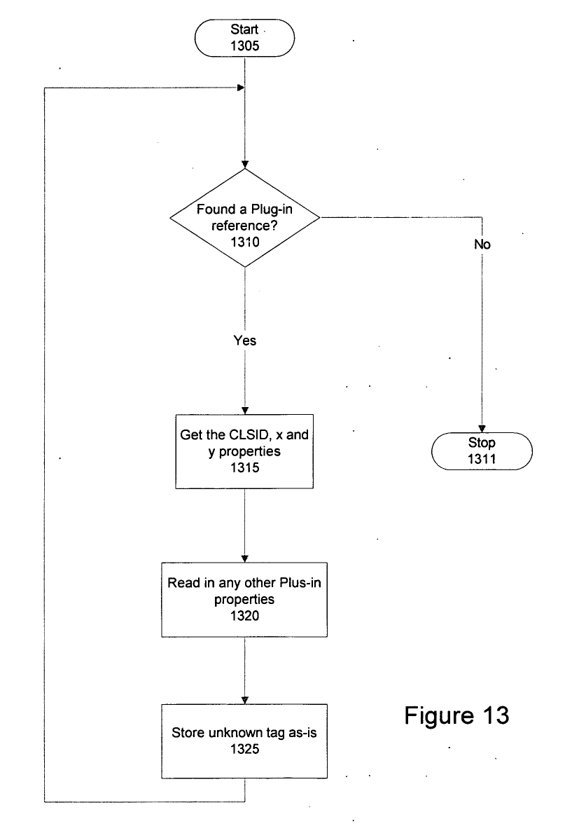

A first method to work out attribute values for Plug-ins will now be described in some detail. FIG. 13 illustrates an exemplary flow chart of the first method to work out attribute values for Plug-ins, in accordance with an embodiment of the present invention. The method begins with the use initiating a process start at Step 1305 most likely through manual selection. The system then prompts for a decision at Step 1310 to determine if a Plug-in reference has been found. If no, this results in termination at Step 1311, and if yes the system proceeds to gathering Plug-in reference CLSID, x and y properties at Step 1315. A read of other Plug-in properties at Step 1320 further gathers any additional tags that each found reference may feature while a tag of unknown ranges is stored as-is at Step 1325.

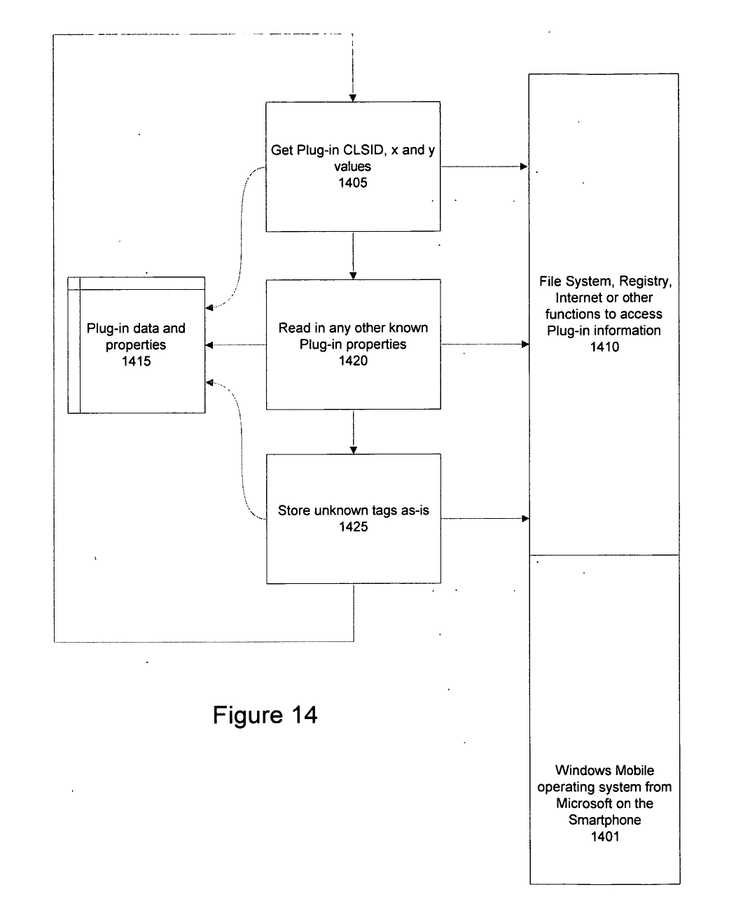

FIG. 14 illustrates an exemplary block diagram of a software system suitable for carrying out the working out attribute values for Plug-ins method shown in FIG. 13, in accordance with an embodiment of the present invention. The Microsoft Smartphone operates on a Windows based mobile operating system 1401 that comprises a File System, Registry, Internet or other functions to access Plug-in information 1410. A plug-in search module 1405 conducts a registry search for Plug-in CLSID, x and y values in File System, Registry, Internet or other functions to access Plug-in information 1410 and stores any Plug-in data and properties found in a Plug-in data file 1415, which is part of internal storage. A Plug-in property reading module 1420 gathers additional tag information from File System, Registry, Internet or other functions to access Plug-in information 1410 and stores additional Plug-in data and properties in Plug-in data file 1415. A tag containing an unknown range of values is stored as-is in internal storage file 1415 by tag storage module 1425, thereby not introducing the potential of values that can cause a system crash.

The first embodiment generally does not allow these custom items to be edited. When the user has edited their Home Screen and the present embodiment writes the new XML file, this custom tag is saved as it was found (i.e. unaltered and in-place) to make sure full compatibility was retained on this unknown tag.

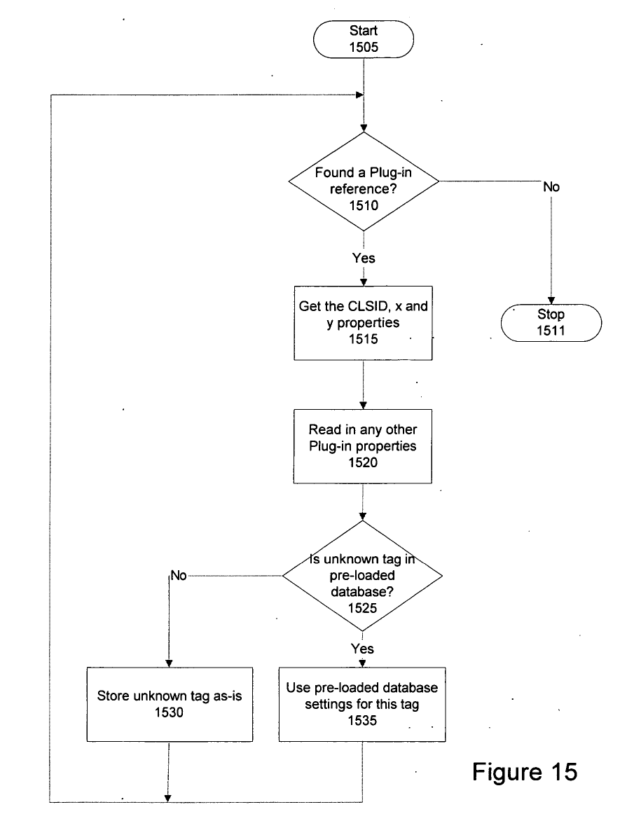

A second embodiment to work out attribute values for Plug-ins will now be described in some detail. FIG. 15 illustrates an exemplary flow chart of the second method for working out attribute values for Plug-ins, in accordance with an embodiment of the present invention. The method begins with the user initiating a process start at Step 1505 most likely through manual selection. The system then prompts a decision at Step 1510 to determine if a Plug-in reference has been found. In no Plug-in reference if found, the process is terminated at Step 1511, and if a Plug-in reference is found, Plug-in reference CLSID, x and y properties are gathered at Step 1515. A reading of other Plug-in properties at Step 1520 further gathers any additional tags that each found reference may feature while a decision point at Step 1525 looks for an unknown tag in the pre-loaded database. The system proceeds to store a tag as-is at 1530 when an unknown tag is not located in pre-loaded database 1520. Upon finding an unknown tag in the pre-loaded database 1525, a tag 1535 uses settings retrieved from the pre-loaded database. This process repeats until no additional Plug-in references 1510 are located thus terminating process 1511.

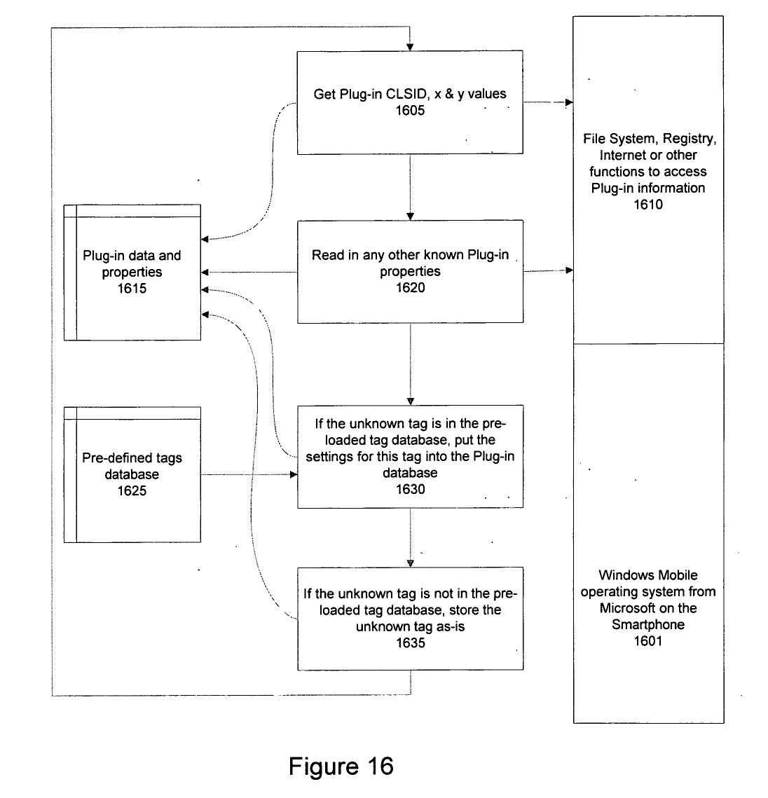

FIG. 16 illustrates an exemplary block diagram of a software system suitable for carrying out the method for working out attribute values for Plug-ins shown in FIG. 15, in accordance with an embodiment of the present invention. The Microsoft Smartphone operates on a Windows based mobile operating system 1601 that comprises a File System, Registry, Internet or other functions to access Plug-in information 1610. A plug-in retrieval module 1605 acquires Plug-in CLSID, x and y values at 1605 from File System, Registry, Internet or other functions to access Plug-in information 1610 and writes relevant Plug-in data and properties data to a plug-in data file 1615. A property reading module 1620 reads in other know Plug-in properties by scanning File System, Registry, Internet or other functions to access Plug-in information 1610 and writes relevant Plug-in data and properties data to plug-in data file 1615. A file storage module 1630 reads from a pre-defined tags database 1625 and stores the settings for this tag into Plug-in database 1615 if the unknown tag is in the pre-loaded database. A tag analyzer module 1635 determines if the unknown tag is not in the pre-defined tags database 1625, and if so, stores the unknown tag as-is into Plug-in database 1615. This system sorts out, preferably, all Plug-in data and properties.

A second embodiment to work out attribute values for Plug-ins is to build in previous knowledge about the system into the present embodiment. For example, if a Plug-in has a tag called “hold”, from trial and error, consultation with the developer or other methods that only values “1” and “2” could be set for this tag may be known. The present embodiment then presents only “1” and “2” to the user, once it has identified the Class ID of the Plug-in. This previous knowledge could be built-into the product, or could be in an external database the Smartphone software references over a network (e.g. the Internet) or other such methods.

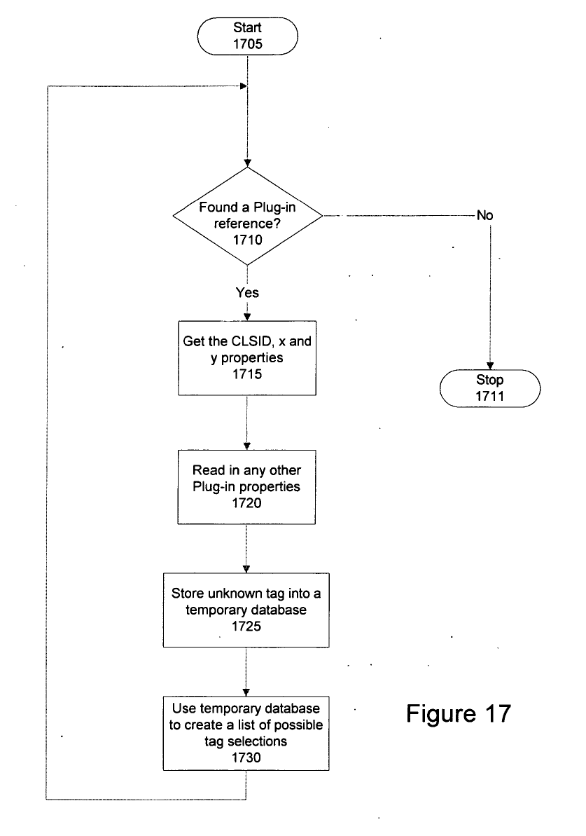

A third embodiment to work out attribute values for Plug-ins will now be described in some detail. FIG. 17 illustrates an exemplary flow chart of the third method to work out attribute values for Plug-ins, in accordance with an embodiment of the present invention. The method begins with the user initiating a process start at Step 1705 most likely through manual selection. The system then prompts a decision at Step 1710 to determine if a Plug-in reference has been found. In no Plug-in reference if found, the process is terminated at Step 1711, and if a Plug-in reference is found, Plug-in reference CLSID, x and y properties are gathered at Step 1715. A reading of other Plug-in properties at Step 1720 further gathers any additional tags that each found reference may feature where the results are stored to a temporary database at 1725 creating a list of possible tag selections at 1730. This process repeats until no additional Plug-In references 1710 are located thus terminating process 1711.

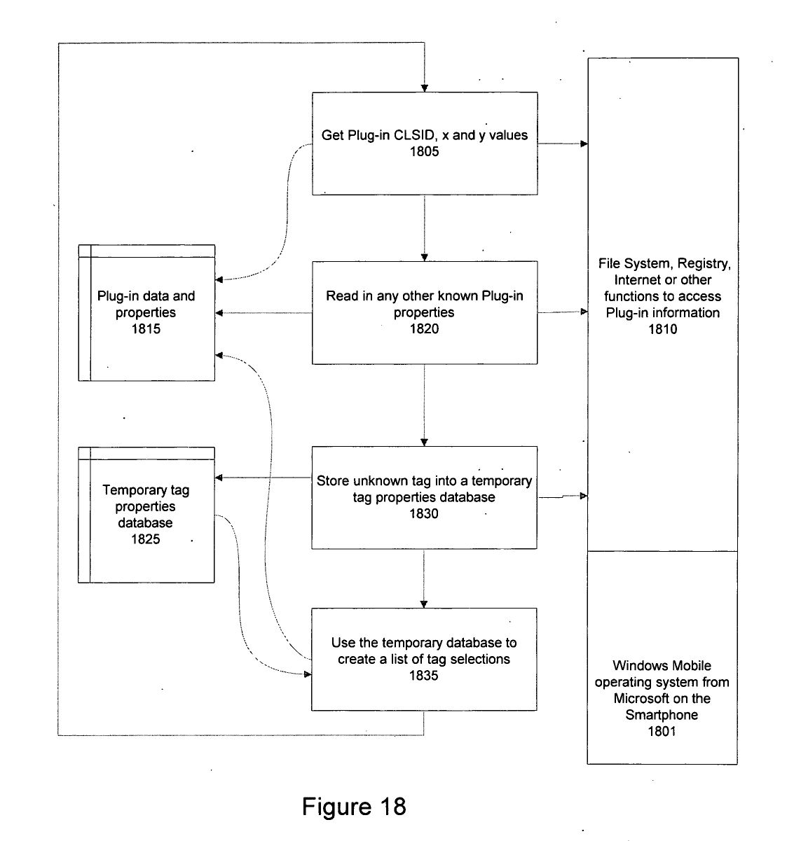

FIG. 18 illustrates an exemplary block diagram of a software system suitable for carrying out the method to work out attribute values for Plug-ins shown in FIG. 17, in accordance with an embodiment of the present invention. The Microsoft Smartphone operates on a Windows based mobile operating system 1801 that comprises a File System, Registry, Internet or other functions to access Plug-in information 1810. A plug-in value retrieval module acquires Plug-in CLSID, x and y values at 1805 from File System, Registry, Internet or other functions to access Plug-in information and writes relevant Plug-in data and properties data to a plug-in data file 1815. A property reading module 1820 reads in other known Plug-in properties function by scanning File System, Registry, Internet or other functions to access Plug-in information 1810 and writes relevant Plug-in data and properties data found to plug-in data file 1815. A file storage module 1830 creates a temporary tag properties database 1825 whereby a temporary tag properties reading module 1835 reads from temporary tag properties database 1825 and updates Plug-in data and properties database 1815. This system sorts out, preferably, all Plug-in data and properties.

The third embodiment for working out attribute values for Plug-ins is to collate information from all the XML files on the system. For example, if this Plug-in were referenced in three XML files on the Smartphone, and this tag were referenced in two of their XML files (and their values were hold=“2” in one file and hold=“3” in the other), the software could read all the parameters this tag could be set to. In this case, one of three things can be done—set hold to 2, 3 or not include the tag at all. These are the only known safe values, so this would present only these options to the user. Other options may be valid, but there would be no knowledge what these were indeed valid.

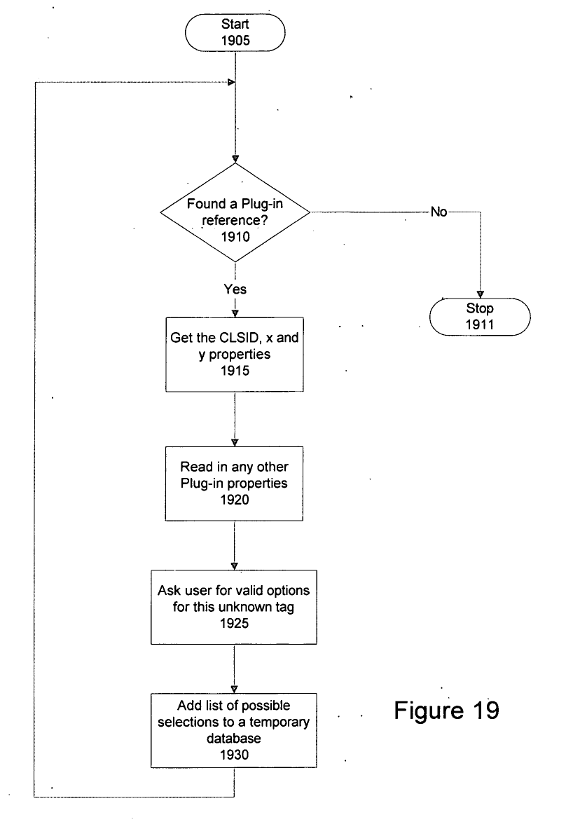

A fourth embodiment to work out attribute values for Plug-ins will now be described in some detail. FIG. 19 illustrates an exemplary flow chart of the fourth method to work out attribute values for Plug-ins, in accordance with an embodiment of the present invention. The method begins with the user initiating a process start at Step 1905 most likely through manual selection. The system then prompts a decision at Step 1910 to determine if a Plug-in reference has been found. In no Plug-in reference is found, the process is terminated at Step 1911, and if a Plug-in reference is found, Plug-in reference CLSID, x and y properties are gathered at Step 1915. A read of other Plug-in properties at Step 1920 further gathers any additional tags that each found reference may feature. A user prompt at Step 1925 asks the user for valid options of an unknown tag which is added to a list of possible selections to in a temporary database at Step 1930. This process repeats until no additional Plug-in references 1910 are located thus terminating process 1911.

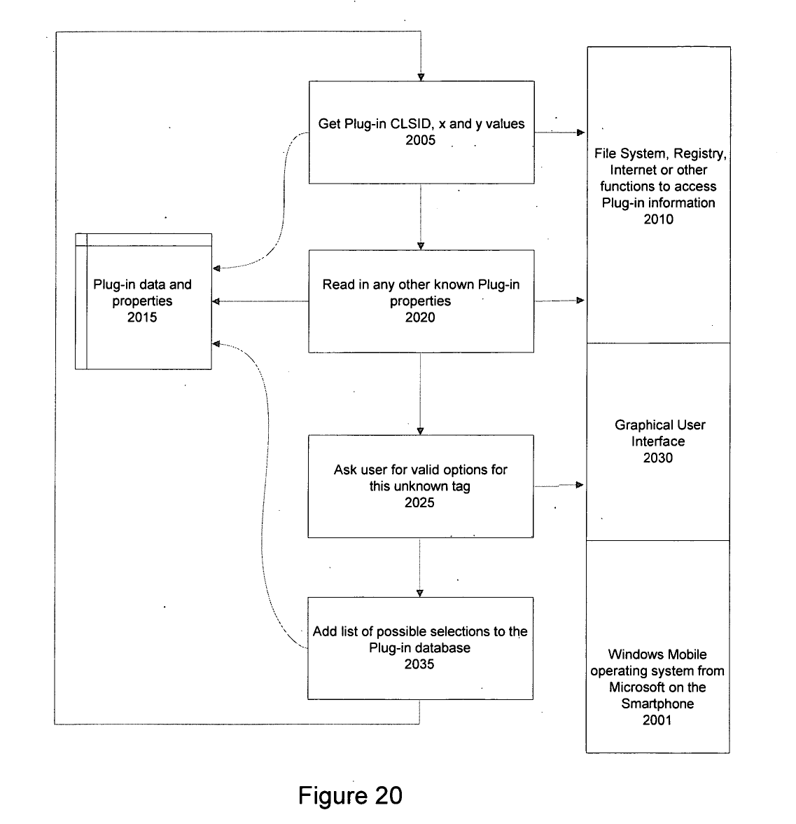

FIG. 20 illustrates an exemplary block diagram of a software system suitable for carrying out the method to work out attribute values for Plug-ins as shown in FIG. 19, in accordance with an embodiment of the present invention. The Microsoft Smartphone operates on a Windows based mobile operating system 2001 that comprises a File System, Registry, Internet or other functions to access Plug-in information 2010 and a Graphical User Interface 2030. A plug-in value retrieval module 2005 acquires Plug-in CLSID, x and y values from File System, Registry, Internet or other functions to access Plug-in information 2010 and is configured to write relevant Plug-in data and properties data found to a plug-in data file 2015. A property reading module 2020 reads in other known Plug-in properties by scanning File System, Registry, Internet or other functions to access Plug-in information 2010 and writes relevant Plug-in data and properties data found to plug-in data file 2015. A prompting module 2025 asks the user for valid options for this unknown tag, displayed on Graphical User Interface 2030. A user reply processing module 2035 processes the user's selections are added to Plug-in data file 2015. This system sorts out, preferably, all Plug-in data and properties.

The fourth embodiment to work out attribute values for Plug-ins is to ask the user about the tag to see if they know more about it. If they do, then they would enter all possible valid values for the tag. The present embodiment then presents each value to the user as possible values to set.

A fifth embodiment to work out attribute values for Plug-ins will now be described in some detail, in accordance with an embodiment of the present invention. The fifth method is to allow the user to enter any information they want about each tag. As mentioned in the first embodiment of avoiding Plug-in crashes, this could cause the whole operating system to crash, but may be an acceptable solution. There is no Figure to show this, as this method relates to the point at which the user selects the Plug-ins on the screen, and not at the point of collating the data.

The preferred method derived from above embodiments to work out attribute values for Plug-ins depends on the particular application; however, a preferred approach is to use a mix of the second embodiment (i.e. prior knowledge—pre-populate the present embodiment with information about Plug-ins known at the time of release), along with collated information since the present embodiment's release (which the present embodiment can then access from the Internet as it does its search), along with a search of the device to work out what valid tag values are currently used (the third method). This allows the present embodiment to know of tags the present embodiment didn't know about before it was released, but still allows the user the maximum amount of configuration of the Home Screen.

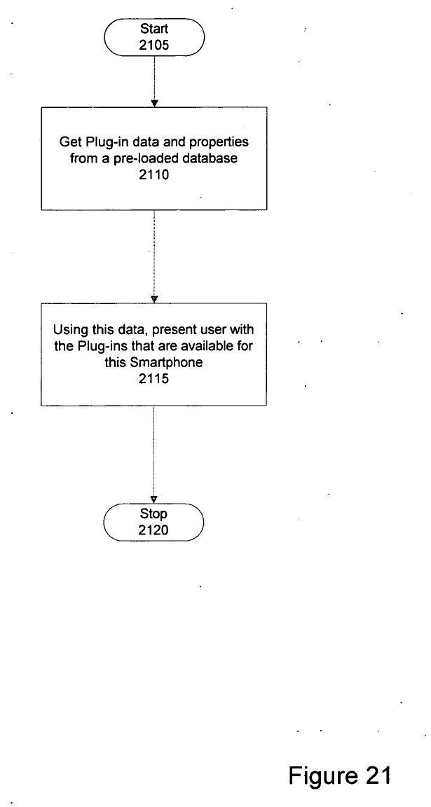

FIG. 21 illustrates an example of a second method to get the information about each Plug-in that has been detected, in accordance with an alternate embodiment of the present invention. The method begins with the user initiating a process start at Step 2105 most likely through manual selection. A pre-loaded database 2110 is searched for Plug-in data and properties. A user prompt at Step 2115 presents user with the Plug-ins that are available for this Smartphone and termination occurs at Step 2120.

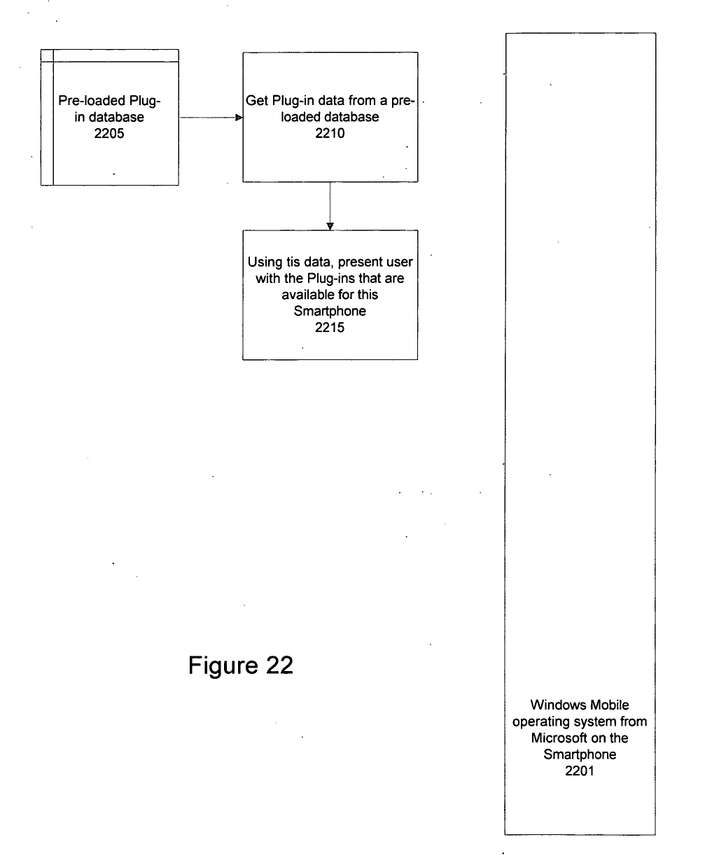

FIG. 22 illustrates an exemplary block diagram of a software system suitable for carrying out the method of acquiring information about each Plug-in that has been detected as shown in FIG. 21, in accordance with an embodiment of the present invention. A plug-in search module 2210 searches for Plug-in data in a pre-loaded Plug-in database 2205. Available Smartphone Plug-ins found are communicated to display module 2215 and presented to the user. It should be appreciated that the present system did not need to call on a Windows mobile operating system from Microsoft on the Smartphone 2201 to execute acquiring and presenting the user with available Plug-ins.

As shown in the Figures, another way to get the information about each Plug-in is to look at the specifications or other information about published Plug-ins from various written sources. For example, a Plug-in manufacturer may publish that they produce a Plug-in with a Class ID “{837FC251-FE69-43ad-84E0-EBCEDEBA0884}” and a readable name “StartMRU”. For example, the manufacturer could then describe that their Plug-in accepts the following tags:

Tag name—“x”

Description—Describes the x position to start drawing the Plug-in information. Valid values are between 0 and the width of the screen in pixels.

Tag name—“y”

Description—Describes the y position to start drawing the Plug-in information. Valid values are between 0 and the height of the screen in pixels.

Tag name—“iconbar”

Description—Describes the height of the Plug-in in pixels. Valid values are either 20 or 40 pixels.

By using this information, one embodiment could collate the information about what Plug-ins are available and what capabilities they have.

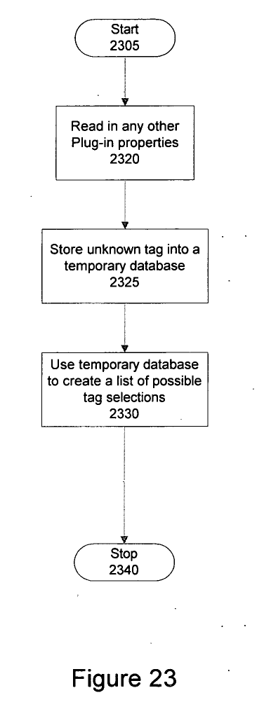

FIG. 23 illustrates an example of a third method to get the information about each Plug-in that has been detected, in accordance with yet another embodiment of the present invention. The method begins with a reading of other Plug-in properties at Step 2320 to gather any additional tags that each found reference may feature where the results are stored to a temporary database at 2325 creating a list of possible tag selections at 2330. The process terminates at Step 2340.

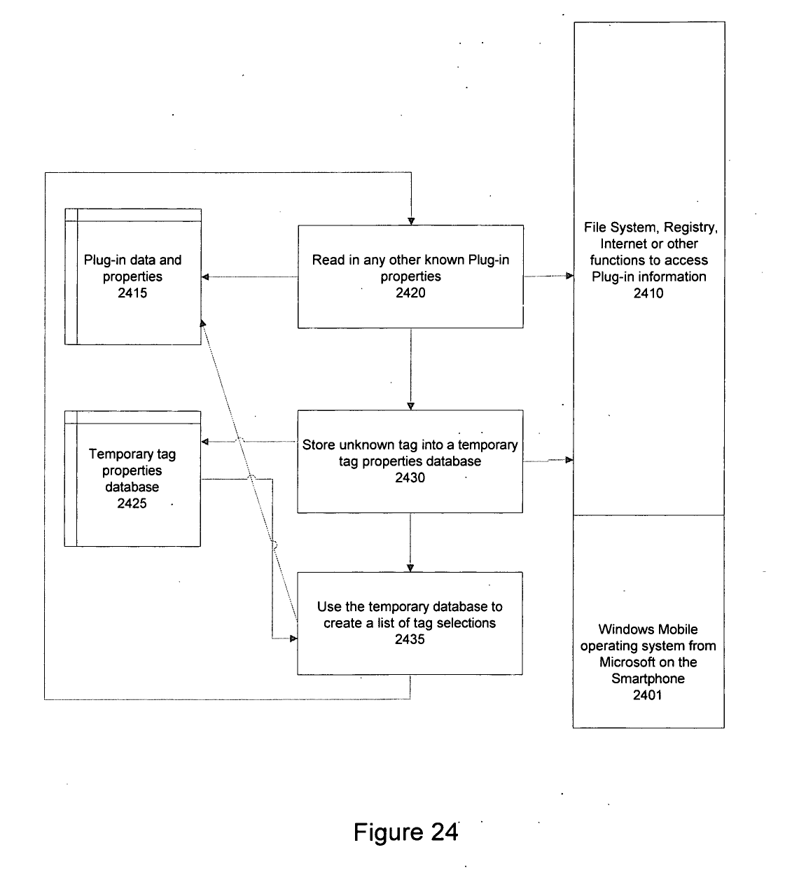

FIG. 24 illustrates an exemplary block diagram of a software system suitable for carrying out the method of acquiring information about each Plug-in as shown in FIG. 23, in accordance with an embodiment of the present invention. The Microsoft Smartphone operates on a Windows based mobile operating system 2401 that comprises a File System, Registry, Internet or other functions to access Plug-in information 2410. A plug-in value retrieval module acquires Plug-in CLSID, x and y values at 2405 from File System, Registry, Internet or other functions to access Plug-in information and writes relevant Plug-in data and properties data to a plug-in data file 2415. A property reading module 2420 reads in other known Plug-in properties function by scanning File System, Registry, Internet or other functions to access Plug-in information 2410 and writes relevant Plug-in data and properties data found to plug-in data file 2415. A file storage module 2430 creates a temporary tag properties database 2425 whereby a temporary tag properties reading module 2435 reads from temporary tag properties database 2425 and updates Plug-in data and properties database 2415. This system sorts out, preferably, all Plug-in data and properties.

The next step of setting edited XML file as the default Home Screen page will now be described in some detail with reference to FIGS. 25 and 26. FIG. 25 illustrates a method of setting an edited XML file as the default Home Screen, in accordance with another embodiment of the present invention. The method begins with the user initiating a process start at Step 2505 which creates a user prompt asking if the user desires to alter existing Home Screen XML file at Step 2510. A user response of yes allows Home Screen XML editing at Step 2525, and thereafter to save the XML Home Screen file at Step 2530. A Smartphone update at Step 2535 informs the Smartphone the Home Screen and colors may have changed. A user response of no when user is asked if they desire to alter existing Home Screen XML file at Step 2510 results in saving the new XML file, comprises Home Screen and color information, at Step 2515, and updating the “Scheme” and “ColorScheme” registry values at Step 2520. Smartphone update at Step 2525 informs the Smartphone the Home Screen and colors may have changed. This information progresses to a termination function at Step 2540.

FIG. 26 illustrates an exemplary block diagram of a software system suitable for carrying out the method of setting an edited XML file as the default Home Screen as shown in FIG. 25 in accordance with an embodiment of the present invention. The Microsoft Smartphone operates on a Windows based mobile operating system 2601 that comprises a Graphical User Interface 2615 and Registry 2625. A plug-in editing module 2610 reads a Plug-in data and properties database 2605 and is configured to save new or edits and saves existing Home Screen XML, files with File System 2615. The edited plug-in information outputted by plug-in editing module 2610 in communicated to a plug-in information saving module 2620, which is configured for update “Scheme” and “ColorScheme” registry values and write them into Registry 2625. A Smartphone update alerting, module 2630 receives a signal from plug-in editing module 2610 indicating an edit operations has occurred and update alerting module 2630 reforms the Smartphone that the Home Screen and colors may have changed.

If another Home Screen XML file is used, this must replace the current XML file. One way to do this is to read tie list of Registry keys in the HKEY_CURRENT_USER\ControlPanel\Home. Under this key, the “Scheme” value tells which XML file is currently being used for the Home Screen. This value can be edited to show the XML file desired for use to the Home Screen. The “ColorScheme” value under this key points to the color scheme the Home Screen (and the rest of the Smartphone operating system) is using to define the default colors to use. Once the present embodiment has altered the color scheme and has saved the results into an XML file, this value should point to the XML file that defines this color scheme. Once these values have been written to the Registry then the Smartphone is informed that the Home Screen XML file has been changed. This is the current method to replace the current XML file. In the future the Windows Mobile operation system for the Smartphone may change how this process occurs. Therefore this may not be the only way to replace the Current XML file.

An alternate approach (not shown) is to configure a software product on a Personal Computer (PC) that enables the user to edit their Home Screen on their PC. Such software applications can have knowledge about the Home Screen Plug-ins associated with some Smartphone devices (i.e. it knows which Plug-ins are installed on a particular device by default), and the software product then allows the user to reposition the Plug-ins on a simulated Smartphone display on the users PC, or by any other method that allows the Plug-ins to be chosen, positioned and their settings selected. Once the user has selected the Plug-ins and/or chosen the color scheme they wish to use, the user can download the new screen design to the Smartphone where it can be selected to display items how the user wishes. However, some potential problems with this approach are that the PC resident software product may not be able to read the information on the Smartphone to determine its current configuration. Instead, the PC resident software product may only know about the devices that the developer told it about, and the PC resident software product only knows about the Plug-ins that came with the Smartphone, and not any subsequent Plug-ins that were installed afterwards by the user. Another potential problem with the PC resident software product approach is by virtue of having the program on the PC, the user requires a PC and a link between the Smartphone and the PC to alter the Smartphone Home Screen. The present approach could be reproduced on any system that is not connected directly to the Smartphone. For example, this approach could be reproduced on a Pocket PC which is linked to the Smartphone or by any computer that is connected to the Smartphone by a network link, such as the Internet.

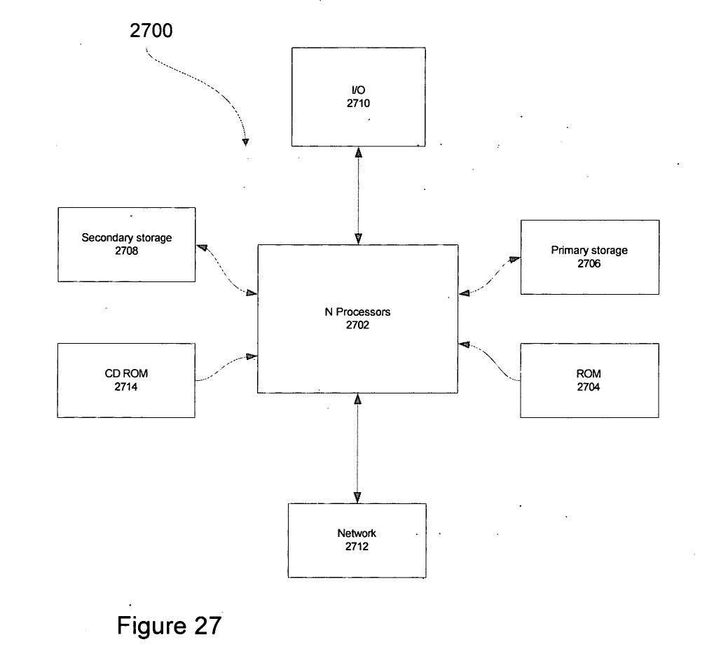

FIG. 27 illustrates a typical computer system that, when appropriately configured or designed, can serve as a computer system in which the invention may be embodied. A computer system 2700 includes any number of processors 2702 (also referred to as central processing units, or CPUs) that are coupled to storage devices including primary storage 2706 (typically a random access memory, or RAM), primary storage 2704 (typically a read only memory, or ROM). CPU 2702 may be of various types including microcontrollers and microprocessors such as programmable devices (e.g., CPLDs and FPGAs) and unprogrammable devices such as gate array ASICs or general purpose microprocessors. As is well known in the art, primary storage 2704 acts to transfer data and instructions uni-directionally to the CPU and primary storage 2706 is used typically to transfer data and instructions in a bi-directional manner. Both of these primary storage devices may include any suitable computer-readable media such as those described above. A mass storage device 2708 may also be coupled bi-directionally to CPU 2702 and provides additional data storage capacity and may include any of the computer-readable media described above. Mass storage device 2708 may be used to store programs, data and the like and is typically a secondary storage medium such as a hard disk. It will be appreciated that the information retained within the mass storage device 2708, may, in appropriate cases, be incorporated in standard fashion as part of primary storage 2706 as virtual memory. A specific mass storage device such as a CD-ROM 2714 may also pass data uni-directionally to the CPU.

CPU 2702 may also be coupled to an interface 2710 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 2702 optionally may be coupled to an external device such as a database or a computer or telecommunications or internet network using an external connection as shown generally at 2712. With such a connection, it is contemplated that the CPU might receive information from the network, or might output information to the network in the course of performing the method steps described herein.

In light of the foregoing teachings, those skilled in the art will readily recognize how to best implement any of the foregoing system modules described depending upon the needs of the particular situation. Similarly, Those skilled in the art will readily recognize, in accordance with the teachings of the present invention, that any of the foregoing method steps and/or system modules may be suitable replaced, reordered, removed and additional steps and/or system modules may be inserted depending upon the needs of the particular application, and that the home screen editor of the present invention may be implemented using any of a wide variety of suitable processes and system modules, and is not limited to any particular computer hardware, software, firmware, microcode and the like. Having fully described at least one embodiment of the present invention, other equivalent or alternative methods of implementing a home screen editor in Smartphone devices according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A home screen editor method for use in smartphone devices having an operating system (OS) capable of executing an application and/or interacting with an application executed on a remote computer that affects the smartphone, the method comprising:
Steps for collating at least one application associated Plug-in data from different sources;
Steps for presenting said collated Plug-in data to a user; and
Steps for enabling the user to customize a Home Screen associated with the OS, the customization at least in part being based upon said collated Plug-in data.

2. The home screen editor method of claim 1, further comprising Steps for determining which of said at least one Plug-ins are displayed on the Home Screen.

3. The home screen editor method of claim 2, further comprising Steps for collating said at least one Plug-ins that are displayed on the Home Screen.

4. The home screen editor method of claim 1, further comprising Steps for determining which properties associated with said at least one Plug-ins are displayed on the Home Screen.

5. The home screen editor method of claim 1, further comprising Steps for changing at least one color associated with the Home Screen.

6. The home screen editor method of claim 1, further comprising Steps for changing at least color one associated with the OS.

7. A home screen editor method for use in smartphone devices having an operating system (OS) capable of executing an application and/or interacting with an application executed on a remote computer that affects the smartphone, the method comprising:
Steps for changing at least one color associated with the OS; and
Steps for changing at least one color associated with a home screen generated by the OS.

8. The home screen editor method of claim 7, further comprising:
Steps for collating at least one application associated Plug-in data from different sources;
Steps for presenting said collated Plug-in data to a user; and
Steps for enabling the user to customize the Home Screen, the customization at least in part being based upon said collated Plug-in data.

9. The home screen editor method of claim 8, further comprising Steps for determining which of said at least one Plug-ins are displayed on the Home Screen.

10. The home screen editor method of claim 9, further comprising Steps for collating said at least one Plug-ins that are displayed on the Home Screen.

11. The home screen editor method of claim 7, further comprising Steps for determining which properties associated with said at least one Plug-ins are displayed on the Home Screen.

12. A home screen editor system for use in smartphone devices having an operating system (OS) capable of executing an application and/or interacting with an application executed on a remote computer that affects the smartphone, the system comprising:
means for collating at least one application associated Plug-in data from different sources;
means for presenting said collated Plug-in data to a user; and
means for enabling the user to customize a Home Screen associated with the OS, the customization at least in part being based upon said collated Plug-in data.

13. The home screen editor system of claim 1, further comprising means for changing at least one color associated with the Home Screen and/or OS.

14. A home screen editor computer program product for use in smartphone devices having an operating system (OS) capable of executing an application and/or interacting with an application executed on a remote computer that affects the smartphone, the computer program product residing on or being distributed across one or more computer readable mediums having a plurality of instructions stored thereon which, when executed by one or more associated processors, cause the one or more processors to:
collate at least one application associated Plug-in data from different sources;
present said collated Plug-in data to a user; and
enable the user to customize a Home Screen associated with the OS, the customization at least in part being based upon said collated Plug-in data.

15. The home screen editor computer program product of claim 14, further cause the one or more processors to determine which of said at least one Plug-ins are displayed on the Home Screen.

16. The home screen editor computer program product of claim 15, further causing the one or more processors to collate said at least one Plug-ins that are displayed on the Home Screen.

17. The home screen editor computer program product of claim 14, further causing the one or more processors to determine which properties associated with said at least one Plug-ins are displayed on the Home Screen.

18. The home screen editor computer program product of claim 14, further causing the one or more processors to change at least one color associated with the Home Screen and/or OS.

19. The home screen editor method of claim 14, in which the OS is based on Microsoft™ Smartphone technology.

20. A computer program product according to claim 14, wherein the computer-readable medium is one selected from the group consisting of a data signal embodied in a carrier wave, an optical disk, a hard disk, a floppy disk, a tape drive, a flash memory, and semiconductor memory.
